(19) United States
(12) Patent Application Publication
(10) Pub. No.: US 2019/0270136 A1
(43) Pub. Date: Sep. 5, 2019

(54) APPARATUS AND METHOD FOR SELECTIVE MATERIAL FUSION THREE-DIMENSIONAL (3D) PRINTING

(71) Applicant: ORD Solutions Inc., Cambridge (CA)

(72) Inventor: Christopher John Elmer Gibson, Cambridge (CA)

(21) Appl. No.: 15/909,866

(22) Filed: Mar. 1, 2018

(51) Int. Cl. B22F 3/00; B22F 3/10; B33Y 10/00; B33Y 30/00

(52) U.S. Cl. CPC B22F 3/008; B22F 3/10; B22F 2003/1042; B33Y 30/00; B33Y 10/00

(57) ABSTRACT

The present disclosure is directed at a system, apparatus and method for printing a full color multiple material 3D object or objects. This disclosure uses fusing (melting or sintering) of selectively deposited powdered material onto thin two-dimensional layers, that are stacked consecutively to the height of the object being printed. At least two materials are deposited, and the object's structural material is interspersed with removable infill, fully supporting the object on subsequent upper layers. When no more support is required above a layer, the removable infill is no longer deposited. Full colour is provided by selectively depositing a dithered combination of transparent, cyan, magenta, yellow, white and black materials around the outer surface of the object. Mixed materials are also supported such as gold coating on a glass, metal, or ceramic.

### FIELD

This disclosure relates to the field of additive manufacturing to create a three-dimensional object. More specifically, this disclosure relates to an apparatus and method of sintering or melting materials to cause binding of such materials to form a solid structure, and adding a subsequent layers of powdered material are added on the previous layer and the process is repeated until a 3D object is created.

### BACKGROUND

As computers within manufacturing have advanced, so have methods of producing 3d computer models and the ability to manufacture these models into objects using rapid prototyping techniques of which additive manufacturing is one of these techniques.

It is well known in the art how to produce selective laser sintering printers. A very early example of this type of printer would be U.S. Pat. No. 4,863,538 (Deckard). Referring to FIG. 5 a typical prior art system is illustrated. These printers typically apply a very thin layer of powdered material in the XY plane. In a typical printer 100, there is a container of powder 120 resting on a plate supported by a piston 112. The plate 112 is pushed up revealing a thin layer of powder 102. A roller 104 rolls across the powder 102 and moves it onto the print bed container 122. Print bed 122 also has a plate supported by a piston 110. A laser 130 is directed towards a scanning device 132 that will reflect the laser across the two dimensional surface of material in the printing bed 122. This scanning is typically done very rapidly in a raster pattern of any desired resolution within practical limits. The energy of the laser 130 is modulated on and off during the raster scanning, thus sintering a selected portion of the powder 108 and leaving unsintered powder 106. The print bed 122 is lowered by one layer thickness and the powder bed 120 is raised by the same amount. The process is then repeated until the 3D object is completely printed. This method is well suited to complex geometries that would be difficult or impossible to manufacture using subtractive techniques, such as with a CNC milling machine. This method has the advantage of contactless layer deposition, higher speed, and fully supported layers and overall a better finished quality than most additive manufacturing methods.

These systems have disadvantages. They inherently only work with a single material type at one time. They also waste material that is not recoverable. The unused powder 106 must be removed from the printed object and although it can be reused to an extent, there is typically significant waste from partially sintered material. The heat effect zone of the laser can be larger than the desired sintering width and unwanted material is semi sintered and requires force to remove. As much as 50% of this material is wasted.

Therefore, there remains a need for an improved method of selectively placing the material thus greatly reducing the waste of semi-sintered powder. There is a need to work with multiple materials of different types and/or colours on the same layer. The present disclosure relates to these needs.

### SUMMARY

In a first aspect, the present disclosure provides a system to print a three-dimensional (3D) object having a support structure comprising a platform moveable between a first position and a second position to provide a surface to print successive layers of each of the 3D object and the support structure; at least a first hopper to contain and deliver at least one base material; a second hopper to contain and deliver a removable infill material; printhead connected to the first and second hoppers and engaged with the platform to print the 3D object, the printhead further comprising: a first dispenser to selectively deposit the at least one base material; and, a second dispenser to selectively deposit the removable infill material; wherein the at least one base material is utilized to print the 3D object and the removable infill material is utilized to print the support structure of the 3D object.

In a second aspect, the present disclosure provides a method of printing a three-dimensional (3D) object having a support structure, the steps comprising: moving a printbed between a first position and a second position to print successive layers of the 3D object and the support structure; using a printhead to: selectively deposit at least one base material utilized to print the 3D object; and, selectively deposit a removable infill material utilized to print the support structure; and, removing the removable infill material from the 3D object.

In another aspect, it is the object of the disclosure to provide a system, apparatus and method for printing a full color 3D multiple material object by selectively depositing a thin cross-sectional layer of a mosaic of powdered materials and then sintering this entire layer. This layer is then displaced down and a new layer is added on top. This is repeated until the 3D object is constructed. The selective deposition is effectively the opposite method of selectively laser sintering; in that the appropriate material is deposited only in the areas wanted and then the entire layer is sintered. This allows a more rudimentary heating element to be used that can flash sinter the entire layer at once or a simple column or rectangular raster subset of the layer. This can be implemented with a basic electrical heater element with a fast activating ceramic shutter, therefore no high power laser is necessary. Melting temperatures may be achieved for specific materials so sintering is not the only form of fusion. Modulated selective laser sintering may still be advantageous to fuse different materials each requiring different temperatures, all on a single layer.

It is therefore possible to have a plurality of materials on a single layer, since the material is selectively deposited. This can be done with multiple passes of the deposition device (print head), each pass depositing a different material; or with a plurality of deposition devices depositing different powders simultaneously.

Removable support materials is used on each layer for areas that do not contain the object. This removable material can be non-sinterable and can be automatically removed with a vacuum upon completion of creating the 3D object. This material can then be reused. By selectively depositing non-sinterable powdered material only where it is needed, the waste of partially sintered powder inherent in the prior art is eliminated.

In another embodiment the removable material can be sinterable but dissolvable such as water soluble or other combinations of material and solvent. Post processing can be done automatically, much faster and with far less waste. A combination of soluble and non-sinterable removable infill can be used to optimize cost and simplification of automatic removal.

A sinterable wall can be made enveloping the object and no material is needed beyond this envelope, thus the entire print bed does not need to be filled as with the prior art.

The outer perimeter of the object can be created with a mixture of compatible materials, such as ceramic and powder coat, of colours cyan, magenta, yellow, black, white and optically transparent dithered to obtain a full coloured finish.

Other aspects of the disclosure will become clear when reading the description of the preferred embodiments along with the accompanying figures.

### BRIEF DESCRIPTION OF THE DRAWINGS

The disclosure will now be described in detail, with reference to the accompanying drawings of preferred and exemplary embodiments, in which:

FIG. 1 is a side view of a complete multiple-material selective deposition sintering printer;

FIG. 2 is an internal cross-sectional view of charged material deposition using a photosensitive static electric charged drum;

FIG. 3 is a cross-sectional side view of a mechanical method of dry powder deposition;

FIG. 4 is a cross-sectional side view of a micro-injector designed for depositing powder held in suspension in a fluid;

FIG. 5 is a cross-sectional side view of a printing system according to the prior art;

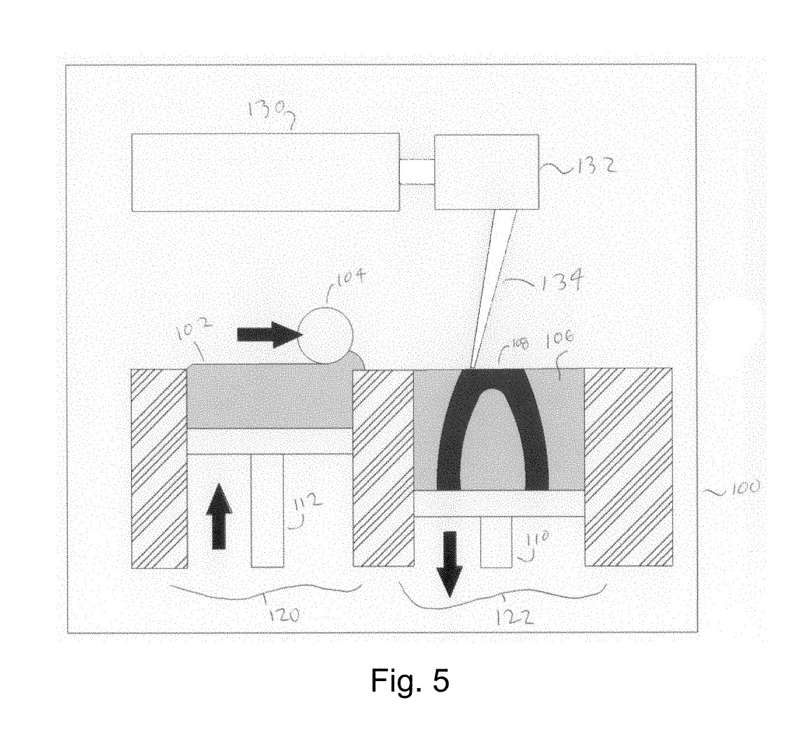

FIG. 6 is a cross-sectional side view of multiple-material deposited illustrating enclosing wall, material overlap, floating objects, overhang and bridging properties, and support material;

FIG. 7 is a perspective view of a one-dimensional light emitting diode array used to expose the photosensitive cylinder;

FIG. 8 is a cross-sectional side view of a two-material powder selective deposition apparatus that uses binder jetting in place of sintering; and,

FIG. 9 is a cross-sectional side view of charged material deposition using two photosensitive static electric charged drums.

### DETAILED DESCRIPTION

The disclosure is directed at a system, apparatus and method for 3D printing an object in full color. A full color 3D multiple material object is printed by selectively depositing a thin cross-sectional layer of a mosaic of powdered materials and then sintering this entire layer. The first layer will be on a planar print bed. The deposition device is used to selectively place powder material onto this bed. Various methods of deposition may be used. It can be deposited in a raster fashion in a small two dimensional square or rectangular area. Another embodiment may deposit an entire rectangular column of material at one time. Still another embodiment may deposit the entire two-dimensional layer of one material in parallel simultaneously. After all material types are deposited for this layer, it will then be sintered. The sintering can also be done in a small raster pattern, in an entire column, or in parallel sintering the entire layer simultaneously. The different methods tradeoff complexity, cost and speed. After a layer is sintered it is then displaced down and a new layer is added on top. This is repeated until the 3D object is constructed.

Three embodiments of deposition devices are disclosed. The first method is a photosensitive and static electric charged cylinder that will attract oppositely charged powder. The cylinder is charged by a corona wire and discharged by scanned modulated laser in a controlled pattern. The charged powder will be transferred from the cylinder to the surface of the print bed to form the current layer. This will deposit an entire column of powdered material as the cylinder is rolled across the surface. Multiple passes of the cylinder are used per layer, one for each material used in that layer. Alternatively, a plurality of cylinders may be used, each for a single different material.

A second deposition embodiment uses a mechanical powder deposition micromanipulator. This will deposit a small amount of powder out of an injector in the shape of the injector. This injector can be moved about the surface in a raster pattern. Alternatively a plurality of injectors may be used to apply powdered material simultaneously. This could be done as a column, a subset array or the entire surface in parallel.

A third deposition embodiment uses a fluid micro-injector. The powdered material is held in suspension in a suitable fluid and is injected in small amounts out of an injector. Again, this injector can be moved about the surface in a raster pattern. Alternatively a plurality of injectors may be used to apply drops of material simultaneously. This could be done as a column, a subset array or the entire surface in parallel. The fluid can be evaporated using a preheater prior to the sintering processes, or directly by the sintering operation.

A fourth embodiment of the invention eliminates the need for sintering until the post process. In this embodiment, material of powder form is selectively deposited onto a layer. This material can be of powdered metal or a polymer or the other suitable materials. The powder may be adapted to also contain an activated binder component. After deposition the binder can be activated to solidify the powder into a mechanically stable form. There are various forms of binders that have various forms of activation. In the preferred embodiment metal powder is used alongside polymer powder that is intended as a support structure for overhangs and spans or bridges. This continues layer upon layer until the object is printed. The object is then removed from the printer and placed in a furnace to sinter the bound metal powder and also anneal it to remove internal stresses. The support polymer will be vapourized in the heating process.

In one aspect, the system and method of the disclosure is directed at 3D printing different types of material in the same print. At a minimum, there will be at least two materials required for printing. The first material is sinterable and will be used to construct the 3D object structurally. The second one material will be removable from the 3D object. This material will herein be called removable infill. The removable infill will be used to fully support the 3D object as it is being constructed. This allows for the creation of solid prints; full bridging of horizontal spans between two pillars without sagging; half bridging or cantilever segments only supported from one pillar; and floating segments that are only supported by removable infill.

In another aspect, the system and method of the disclosure is directed at 3D printing in full colour. The outer perimeter of the object can be created with a mixture of compatible materials, of colours cyan, magenta, yellow, black and white dithered to obtain a full coloured finish. Alternatively, the material may be a blend of the colours so dithering is not required. Optical transparent material may also be blended to obtain a translucent or transparent finish.

In another aspect of the disclosure, the 3D object or objects being printed are enclosed by a sinterable wall of material enveloping the two-dimensional projection of the objects onto the print bed. This wall is used to support and enclose the removable infill such that the entire print bed does not have to be filled. This wall is then discarded post process.

Many powdered materials are able to be sintered as is known in the art, such as wax, plastic, metal, ceramic or glass. Examples of plastic include acrylonitrile butadiene styrene (ABS), polylactic acid (PLA) or others. Plastic includes synthetic polymers such as polystyrene, nylon or others. Removable infill may be a material that will not sinter at the same temperature as the desired sinterable material. An example of this would be aluminum oxide with a melting point of 2072 degrees celsius. This would be compatible with aluminum that has a melting point of 660 degrees celsius. The unsintered aluminum oxide can then be removed post process and reused on subsequent prints. Another example of a removable infill material is polyvinyl alcohol. It is a water-soluble synthetic polymer that is sinterable at low temperatures and can be easily removed post process. Other dissolvable materials exist such as high impact polystyrene that is removed with limonene solution.

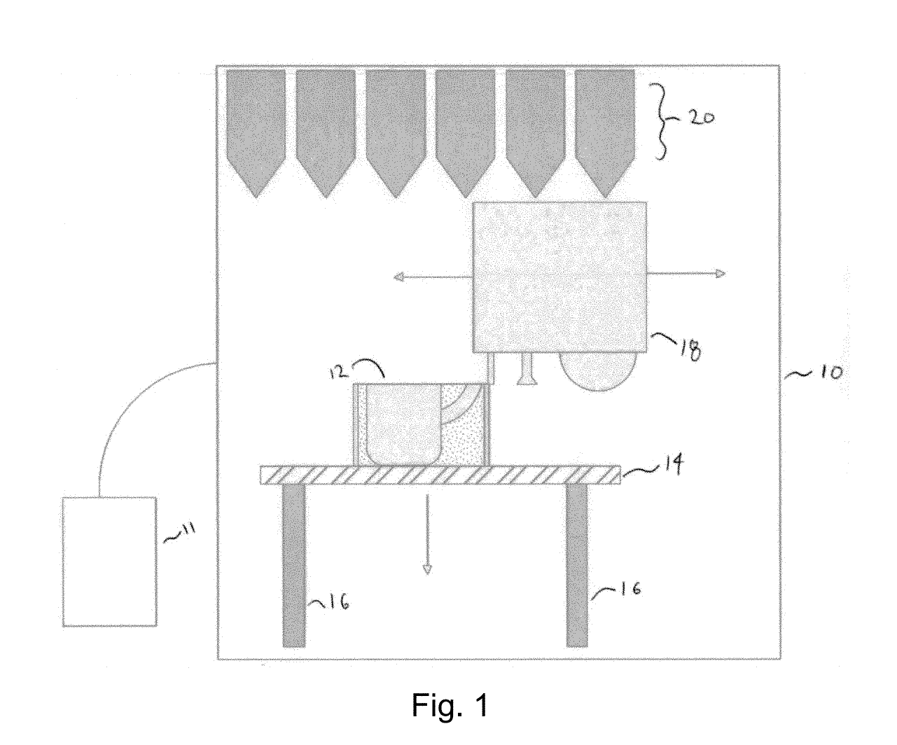

Turning to FIG. 1, a schematic diagram of a system for selective material deposition and fusion is shown. As shown, the system 10 has a combination of selective material deposition and non-selective sintering printhead 18, that moves in one or two dimensions above the print platform 14. The platform 14 is lowered relative to the printhead 18 by pistons 16. A plurality of powdered material is provided to the printhead 18 by hoppers 20. The 3D object 12 being printed is located on the print bed 14 and is shown as partially completed. The CPU 11 will contain a 3D mathematical model of the object 12 being printed in its memory. The CPU will mathematically slice the object 12 into layers of a specified thickness and in a two dimensional grid or raster for each material to be used in the printed object 12. The dimensions of the grid elements will be determined by the physical limitations of the material deposition resolution. This will be clarified during the disclosure of different embodiments of print head 18. Everywhere else in the grid in which the object or objects 12 are not located will be filled with removable infill to support printed objects 12 directly above that position in the layer.

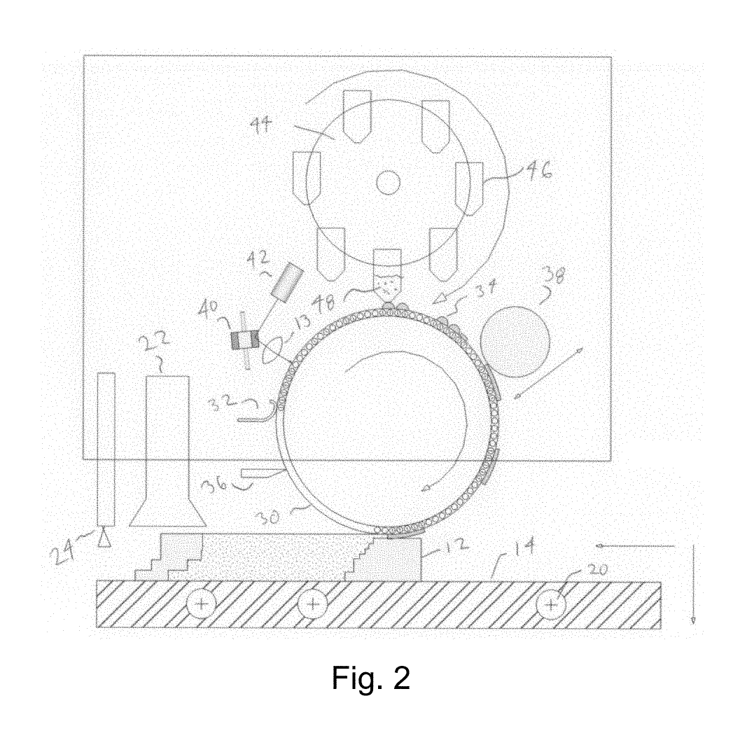

Turning to FIG. 2, a first embodiment of a selective material deposition printhead 18 is shown in schematic form. It is using a method similar to laser printing process. In this embodiment the photosensitive cylinder 30 is shown in end view. The length of the cylinder 30 is at least as long as the print bed 14 is deep. The cylinder 30 rotates as the print head 18 moves from the left to the right of the print bed 14 at a rate such that the surface of the cylinder 30 will be relatively stationary above the print bed 14. A corona wire 32 applies a negative electrostatic charge parallel to the primary axis of cylinder 30 onto the photosensitive coating along the length of the cylinder 30. The cylinder 30 will hold the charge when not exposed to light. A laser 42 is directed at a rotating multifaceted mirror 40 that is oriented such that the laser will scan a horizontal line along the length of the cylinder 30. Other mirrors and lenses 13 may be required. The intensity of the laser is modulated as it is scanned along the line. The modulation pattern is determined mathematically by the CPU 11 slicing the computer model of the object 12 being printed into horizontal strips of rasterized data for that particular material. The CPU 11 will control the modulation of the laser 42 from its memory as the mirror 40 is rotating. The CPU 11 is adapted to know the rotation, position and speed of the rotating mirror 40. The illuminated laser 42 neutralizes the negative charge on the cylinder 30, leaving a static electric inverse image. This is done continuously in raster fashion. As the charged/discharged portions of the cylinder 30 rotate up to the material dispensers 46, negatively charged powdered material 48 is electrostatically attracted 34 to the areas on the cylinder 30 that were illuminated by the laser and have a neutral charge. The negative charged powder is repelled by the like negative charge on the cylinder 30 that was not illuminated by the laser. The optional leveling wheel 38 counter rotates with cylinder 30 and can be used to flatten the powder 34 to a precise thickness. The cylinder 30 continues to rotate until it contacts the current layer of the print bed 14. The powder 34 has a weak attraction to both the cylinder 30 and the print bed 14. The print bed 14 is positively charged 20 so the electrostatic attraction is greater to the current layer of the object 12 being printed and the powder 48 is completely removed from the cylinder 30. A knife edge 36 is optionally used to remove any residual material 34 left on the cylinder 30 after transferring to the surface of the object 12. After completing the transfer of this layer of material 48, the print head 18 is then returned to the leftmost position. The material dispenser wheel 44 is rotated until the next desired material dispenser 46 is in position. The cycle repeats until this selected powder 48 has been deposited onto the current layer of the print bed 14 and the object being printed 12. Powdered materials 48 are intentionally not overlapped and only a single and continuous layer is coated with a mosaic of materials 48. This cycle continues until the layer is complete with as many materials as desired. The material dispensers 46 are refilled as needed by larger material hoppers 20 shown on FIG. 1. On the last pass of the printhead 18 from the left to right, the powder will be sintered. An optional preheater 22 is activated that will bring the material to a temperature just below that required to do sintering. This is followed by the sintering heater 24 that will take the material above the required sintering temperature.

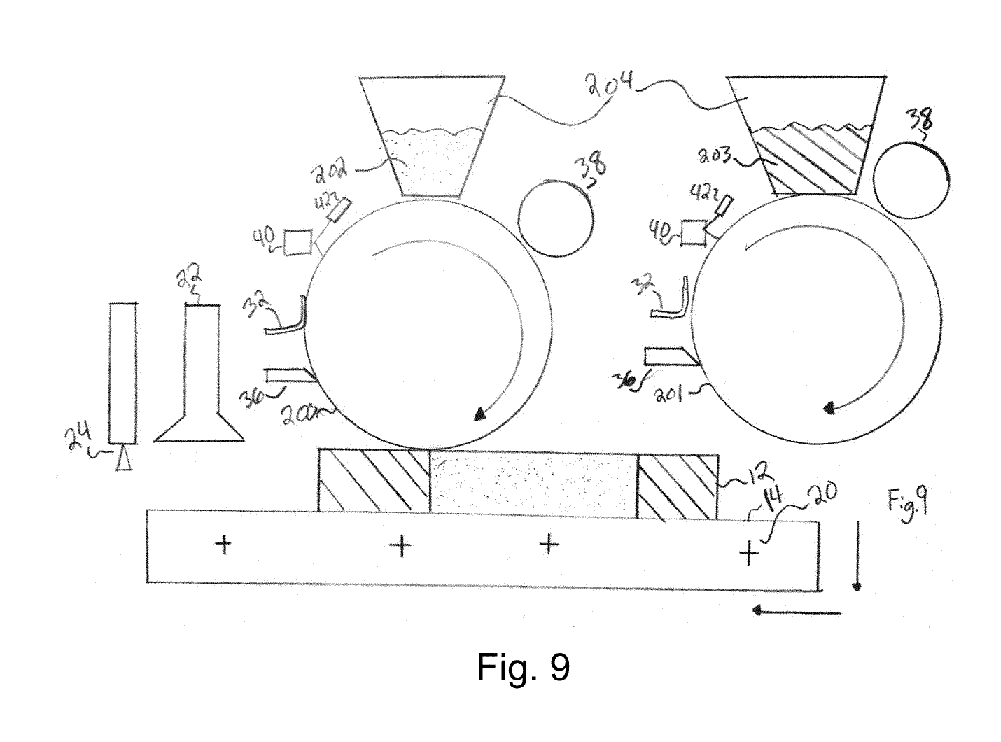

In the preceding embodiment there is a single photo-sensitive cylinder 30. It should be clear that the same result could be obtained by having a separate cylinder 30 for each material, each cylinder spaced apart such that it passes over the single layer one at a time until the mosaic of material is deposited onto the single layer. Specifically, FIG. 9 illustrates this concept that two separate cylinders are used to deposit material in the same manner as shown and described in FIG. 1. There is a hopper suspended above each cylinder holding only a single material 204. The first cylinder 200 rotates depositing material 202 onto the build plate. The first cylinder moves out of the way, either by moving the cylinder or moving the build plate, and the second cylinder 201 is brought into position and then rotates depositing a second material 203 onto the build plate. The first and second materials 202, 203 can be a base material to create a 3D object and an infill, respectively.

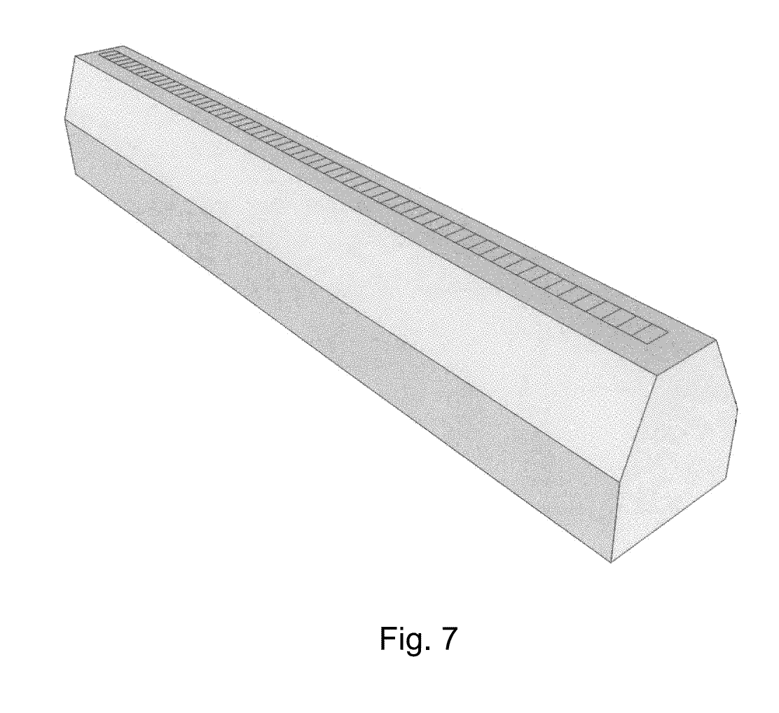

As is known in the art, the laser scanning rotating mirror method can be replaced by other methods of exposing the photosensitive material. Referring to FIG. 7, a representation of a linear array of light emitting diodes (LED) is presented. This can be adapted to illuminate the entire length of the photosensitive cylinder 30 without any additional moving parts. Under control of the CPU, the light intensity of each LED can be modulated as the cylinder 30 is rotated.

In the preceding embodiment the material is given a negative charge and the print bed is positive. Some materials transfer better with a positive charge and negative print bed and changing charge polarity is anticipated and can be done as needed for each individual material. Some materials, such as metal powder is conductive and may or may not be suitable to this deposition method. For ferrous metals a similar method using a magnetic drum and an electromagnetic recording head may be used. This is similar to drum style data hard drives. A stronger magnetic force will pull the material off the drum onto the print head.

In the preceding embodiment a drum is used but other methods may be applicable, such as a planar plate the size of the print bed; that has the image photo-statically or magnetically drawn and material is attracted simultaneously to the entire plate. This plate can then be applied to the printbed and then all material transferred simultaneously to the current layer.

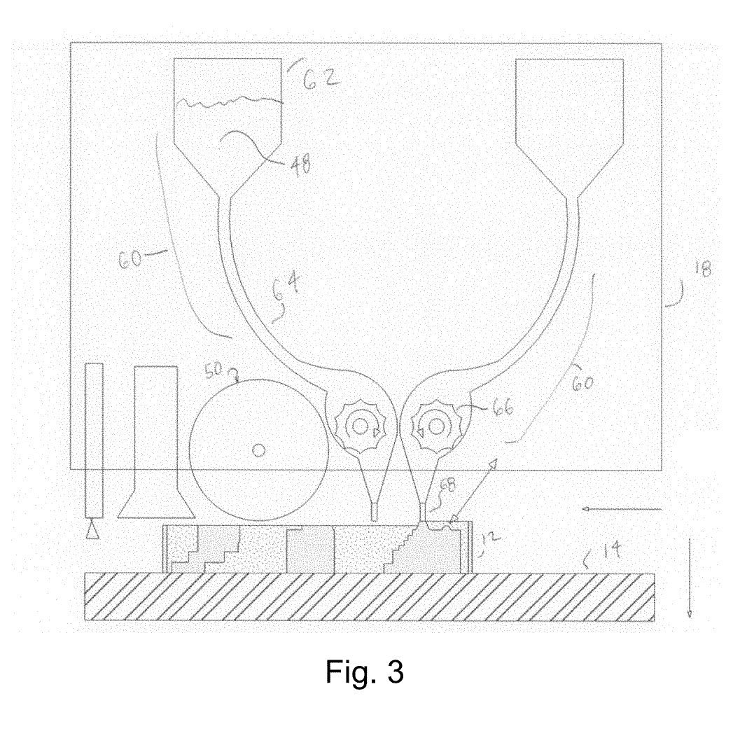

A second embodiment of the selective deposition printhead 18 will now be described. Referring to FIG. 3, in this embodiment powder is applied to the surface using one or more mechanical micromanipulators 60 adapted to deposit very small and controlled amounts of powdered material 48 onto the surface of the object 12 being printed. The nozzle 68 in this embodiment is a fraction of a millimeter in diameter but can be made larger. The print head 18 will be moved in two dimensions above the print bed 14 allowing the deposit of material in the two dimensional layer. In FIG. 3 there are two micromanipulators 60 shown. One is for sinterable material to form the structure of the object 12. The second micromanipulator 60 deposits the removable infill. The material hopper 62 can be refilled with different materials (from hoppers 20 shown in FIG. 1) during the printing of one layer. The number of micromanipulators 60 can be increased as practical to use more types of material and to selectively deposit that material in parallel decreasing the amount of time to print a single layer. The micromanipulator 60 consists of a material hopper 62 holding powdered material 48 that is fed down a tube 64. Toothed wheels 66 will spin under control of the CPU (not shown) to deposit the desired amount of powder out of the nozzle 68. A leveling wheel 50 is optionally used to ensure that the layer height is exact. Sintering is performed in the same manner as was described in the previous embodiment.

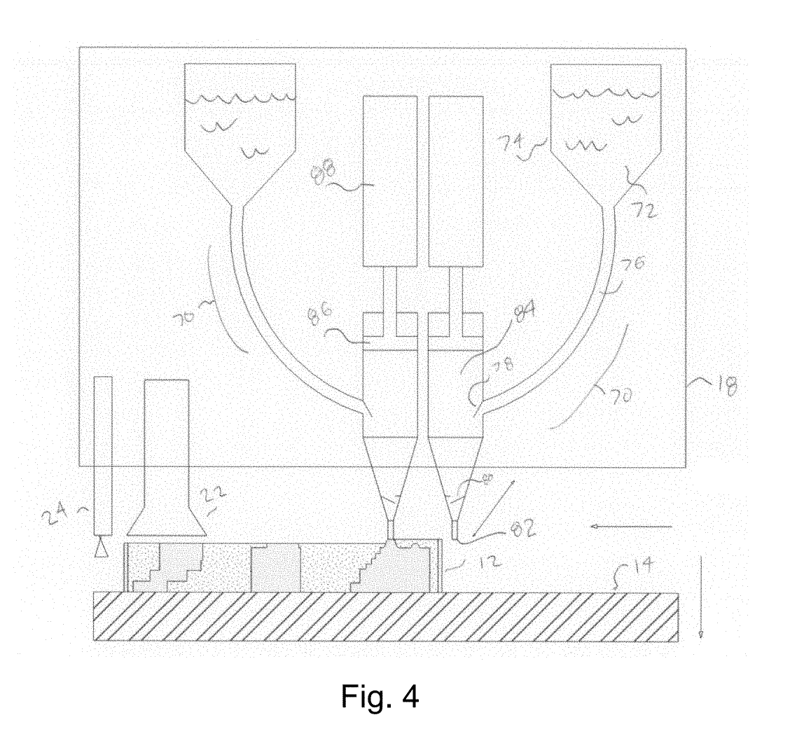

A third embodiment of the selective deposition printhead 18 will be described by referring to FIG. 4. In this embodiment the powdered material 72 is held in suspension in a suitable fluid. In this embodiment the material is microinjected in a small and controlled amount onto the surface of the object 12 being printed. Two microinjectors 70 are shown, one for sinterable material and the second for removable infill. The material hopper 74 can be refilled with different materials 72 during the printing of one layer. The nozzles 82 are a fraction of a millimeter in diameter; however, can be made larger if desired. The print head 18 will be moved in two dimensions above the print bed 14 allowing the deposit of material in the two-dimensional layer. The number of microinjectors 70 can be increased as practical to use more types of material and to selectively deposit that material in parallel decreasing the amount of time to print a single layer. The fluid suspended material 72 is stored in container 74 and is fed down tube 76. The linear actuator 88 moves a piston 86. When the piston 86 is pulled into the actuator 88, chamber 84 develops a low pressure and valve 80 is pulled closed. Valve 78 is pulled open by the low pressure and fluid 72 is drawn into the chamber 84 through tube 76. When the actuator 88 is pushing piston 86 a high pressure is created in chamber 84, thus closing valve 78, opening valve 80 and depositing a controlled amount of fluid out of nozzle 82 onto the surface of the object 12 being printed. In this embodiment, the fluid will be optionally evaporated by pre-heater 22 leaving the powdered material behind. Sintering will proceed in a like fashion as the last two embodiments. Actuator 88 can be a magnetic solenoid or piezo electric or similar, as is known in the art. Extracting actuator 88 pulling piston 86 can be used to prevent oozing of material as the injector is moved over portions of the layer that do not require this material deposition.

In the preceding descriptions the sintering mechanism was shown to be part of the print head 18. The print head 18 can be removed from above the printbed 14 and a heat device either smaller than the printbed, or the same size of the print bed can be placed above. The entire layer can be sintered at once or in sections.

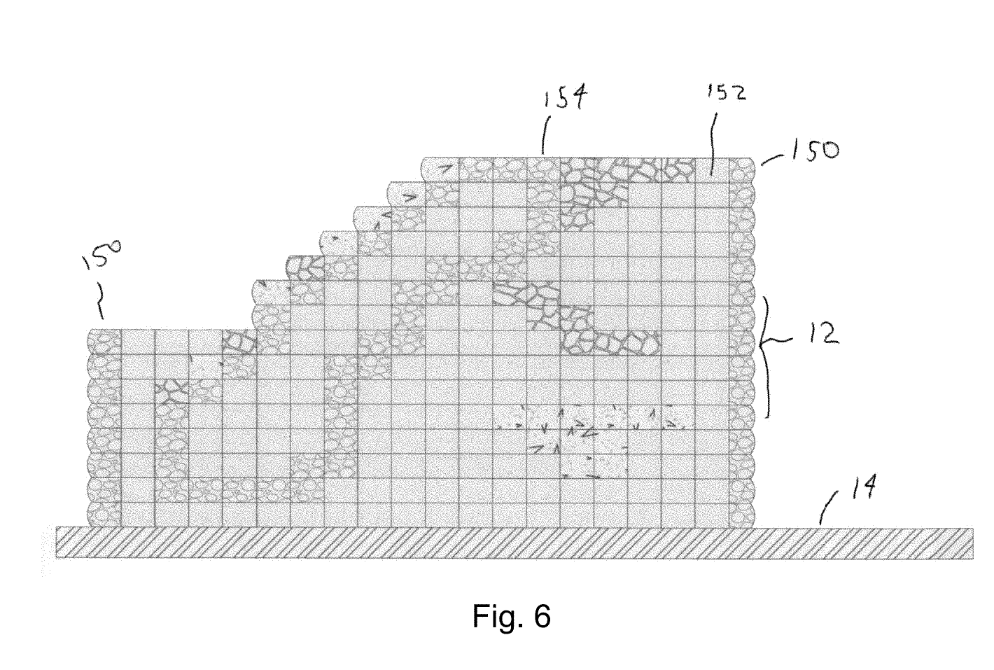

All embodiments of the print head 18 have the same goal, that is to selectively deposit powdered material in a very thin primarily two-dimensional layer. Referring to FIG. 6, the advantages of selective material deposition will be explained. In this example a cross section of a printed object is shown. The print volume is smaller than the print bed 14. This is accomplished by sintering support walls 150 that will envelope the objects being printed. This is required if the removable infill 152 is a non-sintering material that remains in powder form. If the removable infill 152 is sinterable and soluble then the walls 150 will not be needed. In this example the leftmost wall 150 ends at a lower height than the rightmost wall 150. That is because there is no longer removable infill required to support any structure above this height on the left side of the objects. Print speed efficiency is increased by not being forced to fill the entire print bed 14 with powder, as required with prior art. Various sinterable structure materials 154 are shown by way of example containing cantilevered, bridged and floating structures, supported by removable infill 152. As shown, the printed object's removal from the print bed 14 is simplified by depositing only removable material on the first layer. Specific material can now be used very sparingly, for example, a single layer thickness of gold can be used to coat an object of a different compatible base material such as nickel on copper or even directly to glass. The various materials 154 must be sinterable at compatible temperatures. For example, it will not be possible to sinter both metal powder on the same layers as plastic powder. This can be overcome by selectively fusing the structure materials with a raster scanned and modulated laser, as is known in the art, providing for an appropriate temperature for each material type.

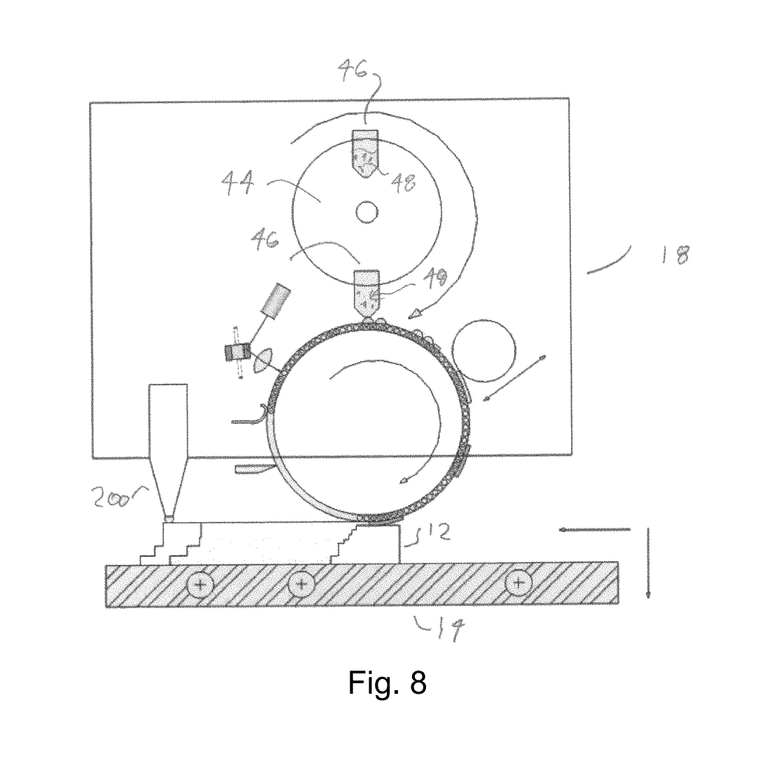

With reference to FIG. 8, an alternate embodiment of the printhead 18 as shown in FIG. 2 will now be described. Specifically, preheater and sintering heater (from FIG. 2) are not used. Instead a binder jet 200 is used to bind the selectively deposited powder into a mechanically stable form. In this exemplary embodiment only two powdered materials 48 are used. One is a form of powdered metal and the second is a polymer that is intended to provide support material for the metal. This will provide support for metal structures such as overhangs, spans and bridges, and hollow structures. The polymer is intended to be vapourized in a subsequent post process of heating the entire printed object. In this embodiment the deposited powder 48 is sprayed with a binder such as cyanoacrylate by the binder jet 200 using thermal or piezoelectric ink jet technology, as is known in the art. In this manner, only the selectively deposited material 48 is bound. After the binder is cured the powder is now solidified into a mechanically stable form. This process continues layer upon layer until the entire object 12 is printed. The object 12 is removed from the printbed 14 and placed in a furnace (not shown) to sinter the bound metal powder and also anneal it to remove internal stresses. The support polymer will be vapourized in the heating process.

Although a selective binder jet 200 is shown in FIG. 8, it is possible to replace this with just a simple spray of binder onto a column of the layer as it passes over the layer or even spray the entire layer at once. This is possible since there is no material present that should not be bound. Other forms of binder are possible and anticipated such as binding material added to the powder that is activated with water, other glues or other suitable liquids, binder activated by heat or binder that are UV curable. Curing of the various types of binders may be hastened using heat or chemical accelerants.

Although there are only some embodiments disclosed for the print head described above there are other methods that can be employed to selectively deposit powdered material. Wax thermal printing and selective adhesive transfer are some other examples. Some printhead embodiments are more suited to a type of material than others. It is anticipated that multiple printhead combinations can be provided as needed to accommodate the types of material supported for a given application.

In the preceding description, for purposes of explanation, numerous details are set forth in order to provide a thorough understanding of the embodiments; however, the specific details are not necessarily required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

A worker skilled in the art would appreciate that the preceding embodiments describe printheads able to be used for printing at least one base material to print the 3D object, and at least one removable infill material to print the removable support structure of the 3D object. It is noted that the infill material can be removed without machining as the infill material has certain characteristics. First, the infill material can have a much higher sinter temperature than the base material so that it is not sintered during the heating process and therefore the powder can be poured out, vacuumed out or blown off. Second the infill material could be burned out during post sintering. Third, the infill material could be soluble in water or another chemical that the base material is impervious to, such that the infill material would wash away. Fourth, the infill material could be dissolved in an electrolysis process of which the base material is impervious to. A worker skilled in the art would also appreciate that both of the base material and the infill material are powdered materials, in a preferred embodiment.

The above-described embodiments are intended to be examples only. Alterations, modifications and variations can be effected to the particular embodiments by those of skill in the art without departing from the scope, which is defined solely by the claims appended hereto.

1. A system to print a three-dimensional (3D) object having a support structure comprising:
a platform moveable between a first position and a second position to provide a surface to print successive layers of each of the 3D object and the support structure;
at least a first hopper to contain and deliver at least one base material;
a second hopper to contain and deliver a removable infill material;
a printhead connected to the first and second hoppers and engaged with the platform to print the 3D object, the printhead further comprising:
a first dispenser to selectively deposit the at least one base material; and,
a second dispenser to selectively deposit the removable infill material;
wherein the at least one base material is utilized to print the 3D object and the removable infill material is utilized to print the support structure of the 3D object.

2. The system of claim 1 wherein the first dispenser is a first selectively charged cylinder and the second dispenser is a second selectively charged cylinder.

3. The system of claim 2 wherein the platform is positively charged to attract a negatively charged fusible material from the first selectively charged cylinder.

4. The system of claim 1 wherein the first dispenser is a first microinjector and the second dispenser is a second microinjector, and wherein each of the at least one base and removable infill materials are powdered materials.

5. The system of claim 4 wherein the first microinjector is further comprised of first and second valves and pressurized chamber containing a first fluid.

6. The system of claim 4 wherein the second microinjector is further comprised of first and second valves and a pressurized chamber containing a second fluid.

7. The system of claim 1 wherein the first dispenser is a first micromanipulator and the second dispenser is a second micromanipulator, and wherein each of the at least one base and removable infill materials are powdered materials.

8. The system of claim 7 wherein the first microinjector is further comprised of a first toothed wheel and the second microinjector is further comprised of a second toothed wheel.

9. The system of claim 1 wherein the at least one base material is not fusible at the same temperature as the removable infill material.

10. The system of claim 1 wherein the at least one base material is fusible at the same temperature as the removable infill material and the removable infill material is soluble in a solvent solution.

11. The system of claim 1 wherein the printhead is further comprised of a heat source to non-selectively fuse successive layers of the 3D object and the support structure.

12. The system of claim 1 wherein the at least one base material and the removable infill material contain at least a binding agent that is activatable to solidify the at least one base material and the removable infill material.

13. A method of printing a three-dimensional (3D) object having a support structure, the steps comprising:
moving a printbed between a first position and a second position to print successive layers of the 3D object and the support structure;
using a printhead to:
selectively deposit at least one base material utilized to print the 3D object; and,
selectively deposit a removable infill material utilized to print the support structure; and,
removing the removable infill material from the 3D object.

14. The method of claim 11 further comprising the step of heating at least the at least one base material and the removable infill material with a heater to solidify the 3D object.

15. The method of claim 11 further comprising the step of adding a binding agent in the at least one base material and the removable infill material, wherein the binding agent is activatable to solidify the at least one base material and the removable infill material.
